(19) United States
(12) Patent Application Publication
(10) Pub. No.: US 2010/0075886 A1
(43) Pub. Date: Mar. 25, 2010

(54) CLEANING COMPOSITION

(76) Inventors: Anju Deepali Massey Brooker, Newcastle (GB); Weihua LAN, Newcastle (GB); Dan XU, Newcastle (GB); Alberto MARTINEZ-BECARES, Newcastle (GB); David William YORK, Newcastle (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/553,356

(22) Filed: Sep. 3, 2009

(30) Foreign Application Priority Data
Sep. 23, 2008 (EP) 08164933.7

(51) Int. Cl. C11D 3/386; C12S 9/00

(52) U.S. Cl. 510/226; 510/392

(57) ABSTRACT

An alkaline cleaning composition for use in aqueous medium comprising nanoparticles or a nanoparticles precursor and a polymeric nanoparticle-protease compatibilizer.

### TECHNICAL FIELD

The present invention is in the field of cleaning, in particular it relates to cleaning compositions comprising nanoparticles or a nanoparticle precursor. The invention also relates to a method of cleaning using compositions comprising nanoparticles.

### BACKGROUND OF THE INVENTION

In the field of automatic dishwashing the formulator is constantly looking for improved and simplified cleaning compositions and methods. There is a need for finding compositions having a more environmentally friendly profile, i.e. using more environmentally friendly ingredients, reducing the number of ingredients, reducing the amount needed for achieving good cleaning and being more effective than current compositions.

Cleaning compositions comprising nanoparticles are known in the art. Nanoparticles can present serious incompatibility issues with other cleaning ingredients when placed in a wash liquor (aqueous medium). Nanoparticles have a substantial fraction of their atoms or molecules at the surface and can negatively interact with charged molecules.

It has been found that not all enzymes are effective in compositions comprising nanoparticles.

While amylases commonly used in the cleaning field prove effective, the most commonly used proteases seem to be completely ineffective and hence compositions comprising nanoparticles fail to provide good proteinaceous cleaning. It is desirable to have a product that provides both strong overall cleaning and soil release benefits, as well as effective removal of proteolytic stains such as egg and meat.

Thus an objective of the present invention is to provide a cleaning composition that overcomes some or all of the above problems.

### SUMMARY OF THE INVENTION

According to the first aspect of the present invention, there is provided an alkaline cleaning composition, i.e. a composition having a pH greater than 7, preferably from about 8 to about 12 and more preferably from about 9 to about 11 as measured at 1% by weight in aqueous solution at 20° C.

The composition of the invention is for use in an aqueous medium, i.e. for dissolving/dispersing the composition in water, usually tap water, to form a wash liquor. The wash liquor can be applied onto the surface to be cleaned but preferably, the surface is cleaned by immersion into the wash liquor.

The cleaning composition of the invention is suitable for use on any type of surfaces, in particular hard surfaces. The composition is especially suitable for use in automatic dishwashing.

The composition of the invention provides excellent cleaning of hard surfaces. In particular, the composition of the invention provides outstanding cleaning when used in automatic dishwashing, including first time cleaning, second time cleaning and finishing, including shine, glass and metal care. The composition of the invention provides excellent removal of proteinaceous soils as well as excellent removal of tough food soils, including cooked-, baked-, and burnt-on soils.

By “nanoparticles” herein are meant particles, preferably inorganic particles, having a particle size of from about 1 nm to about 500 nm, preferably from about 5 nm to about 400 nm, more preferably from about 10 to about 100 nm, and especially from about 15 to about 60 nm The particle size can be measured using a Malvern zetasizer instrument as detailed herein below. The particle size referred to herein is the z-average diameter, an intensity mean size. Preferably, the nanoparticles for use in the composition of the invention are inorganic nanoparticles, more preferably clays (sometimes referred herein as “nanoclays”) and specially preferred synthetic nanoclays, such as those supplied by Rockwood Additives Limited under the Laponite trademark.

The cleaning composition of the invention comprises nanoparticles or a nanoparticles precursor, the nanoparticles precursor is a secondary particle which releases nanoparticles when introduced into a wash liquor. By “nanoparticles precursor” is herein meant a secondary particle (the terms “secondary particle” include aggregates) being able to generate nanoparticles when 0.2 g of the precursor is added to 1 l of water having a pH of 10.5 (KOH being the alkalising agent) at 20° C. and stirred at 500 rpm for 30, preferably for 15 and more preferably for 5 minutes.

Nanoparticle-Protease Compatibilizer

Without wishing to be bound by theory, it is believed that the nanoparticle-protease compatibilizer modifies the interface of the nanoparticle and/or protease and stabilizes aqueous solutions comprising a mixture thereof. Preferred polymeric nanoparticle-protease compatibilizers include homopolymers, block or comb copolymers.

A polymeric material is considered a nanoparticle-protease compatibilizer if the activity of a protease at a given pH (10.5) in a solution containing the compatibilizer, in the presence of nanoparticles is at least 40%, preferably at least 50%, more preferably at least 70% or most preferably at least 80% of that of a solution comprising the protease (i.e., free of nanoparticles and nanoparticle-protease compatibilizer). The method used to calculate the activity of the protease is a DMC assay. The absorbance of a solution containing the protease (and the DMC reagents) is compared with the absorbance of a solution containing the protease (and the DMC reagents), plus the nanoparticles and the nanoparticle-protease compatibilizer. Absorbance and activity are directly related so the absolute value of the protease activity is not needed for the purpose of evaluating whether a polymer is a nanoparticle-protease compatibilizer.

A detailed method to determine if a polymeric material is considered a nanoparticle-protease compatibilizer is detailed herein below.

In a preferred embodiment, the polymeric nanoparticle-protease compatibilizer is selected from polymers comprising non-ionic groups. It has been found that compositions having excellent nanoparticles-enzyme compatibility can be achieved by using polymeric materials capable of forming hydrogen bonding or any other type of dipolar-dipolar bonding with the nanoparticles. Preferred for use herein are polymers having non-ionic groups at pH of about 10.5, more preferred the polymers should absorb to the nanoparticles surface by means of hydrogen bonding or any other type of dipolar-dipolar interactions or a mixture thereof. Particularly suitable for use herein as nanoparticle-protease compatibilizer are homopolymer, block copolymers and comb polymers. Preferred moieties for use in the polymers herein include: amines, amides, imides, heterocyclic groups, alkylene oxides, alkylene glycols, alkyl glycol ethers or mixtures thereof. It has been found that comb polymers comprising i) in the backbone a moiety comprising amines, amides, imides, heterocyclic groups, polypropyleneoxides or mixtures thereof; and ii) as pendant group at least one moiety comprising ethyleneoxide, ethylene glycols, propylene glycol, ethylene glycol alkyl, alkyl glycols, alkyl glycol ether, ethylene glycol esters, propyleneoxides, or mixtures thereof.

Homopolymers and copolymers of polyethylene oxide and polyethylene glycols have been found especially suitable for use as nanoparticle-protease compatibilizer. In a preferred embodiment the nanoparticle-protease compatibilizer is a polyethylene glycol, preferably having a molecular weight of from about 1,000 to about 100,000, more preferably from about 5,000 to about 40,000.

Preferred nanoparticle-protease compatibilizer includes linear polyamines, polyalkylene polyamines, polyamidoamines, polyimines, polyethyleneimines and mixtures thereof.

In a preferred embodiment, the nanoparticle-protease compatibilizer comprises a moiety comprising at least one heteroatom selected from the group consisting of nitrogen, oxygen, sulphur or mixtures thereof. In a more preferred embodiment the moiety comprises a nitrogen-containing cyclic unit, more preferably a nitrogen heterocycle (i.e. a cyclic unit comprising nitrogen as part of it).

The present inventors have found that nanoparticles should be dispersed in the cleaning medium to provide optimum cleaning and care benefits. The aqueous medium is usually tap water. Tap water usually contains hardness ions, the amount and type of ions varies from one geographic area to another. Nanoparticles dispersions can be easily destabilized by hardness ions and they can give rise to flocculation and precipitation of the nanoparticles, this not only impairs the cleaning capacity of the nanoparticles but might also contribute to soiling of the surfaces to be cleaned. It is believed that the nanoparticle-protease compatibilizer, preferably those containing a nitrogen heterocycle, can also help to maintain the nanoparticles dispersed in the cleaning medium.

Nitrogen heterocycles are preferred for use herein. Preferred heterocycles are selected from azlactone, azlactam, more preferred heterocycles include pyrrolidone, imidazole, pyridine, pyridine-N-oxide, oxazolidone and mixtures thereof. Especially preferred polymers are polyvinyl imidazole, polyvinyl pyrrolidone, polyvinyl pyridine-N-oxide and mixtures thereof.

Especially preferred are those polymers and copolymers wherein no optional anionic moiety (at pH of 10.5) is present.

In more detail, moieties containing a nitrogen heterocycle for use herein include but are not limited to: vinylpyridines such as 2-vinylpyridine or 4-vinylpyridine; lower alkyl (C₁-C₈) substituted N-vinylpyridines such as 2-methyl-5-vinylpyridine, 2-ethyl-5-vinylpyridine, 3-methyl-5-vinylpyridine, 2,3-dimethyl-5-vinylpyridine, and 2-methyl-3-ethyl-5-vinylpyridine; methyl-substituted quinolines and isoquinolines; N-vinylcaprolactam; N-vinylbutyrolactam; N-vinylpyrrolidone; vinyl imidazole; N-vinylcarbazole; N-vinylsuccinimide; maleimide; N-vinyl-oxazolidone; N-vinylphthalimide; N-vinylpyrrolidones such as N-vinylthiopyrrolidone, 3 methyl-1-vinylpyrrolidone, 4-methyl-1-vinylpyrrolidone, 5-methyl-1-vinylpyrrolidone, 3-ethyl-1-vinylpyrrolidone, 3-butyl-1-vinylpyrrolidone, 3,3-dimethyl-1-vinylpyrrolidone, 4,5-dimethyl-1-vinylpyrrolidone, 5,5-dimethyl-1-vinylpyrrolidone, 3,3,5-trimethyl-1-vinylpyrrolidone, 4-ethyl-1-vinylpyrrolidone, 5-methyl-5-ethyl-1-vinylpyrrolidone and 3,4,5-trimethyl-1-vinylpyrrolidone; vinylpyrroles; vinylanilines; and vinylpiperidines.

In a preferred embodiment, the nanoparticle-protease compatibilizer is a comb polymer comprising a backbone and pendant groups wherein the backbone comprises a moiety comprising nitrogen and the pendant groups are non-ionic.

Preferably the backbone comprises groups selected from one or more of alkylene amines, alkyl pyrrolidones and alkyl imidazoles or mixtures thereof.

Preferred pendant groups for use herein include moieties comprising alkoxylates, alkyl acetates and alkylene glycols. In particular, ethylene oxide, ethylene glycol, ethylene glycol dimethyl ether, ethylene glycol monomethyl ether, propylene oxide, propylene glycol, methyl methacrylate, vinyl alcohol, vinyl acetate, oxyethylene, vinyl methyl ether, and dimethylsiloxane, or mixtures thereof.

Especially preferred for use herein include comb polymers, the backbone comprises groups selected from one or more of alkylene amines, alkyl pyrrolidones and alkyl imidazoles or mixtures thereof and the pendant groups are selected from one or more of the group comprising alkyl acetates and alkylene glycols. Examples would include comb polymers wherein the backbone comprises vinylimidazole and/or vinylpyrrolidone units and the pendant groups are polyalkylene glycols, preferably polyethylene glycols. Preferably, the comb polymer comprises a plurality of different moieties, this increases the tolerance of the polymer to the medium.

Without wishing to be bound by theory it is believed that said pendant groups can provide enhanced charge and/or steric stabilization to the nanoparticles within the wash liquor thereby enabling strong performance across a wide range of water hardness.

Suitable commercially available materials for use as nanoparticle-protease compatibilizer include the water-soluble polymers sold by BASF under the Sokalan tradename, series HP, examples of these polymers include: Sokalan HP 165, Sokalan HP 50, Sokalan HP 53, Sokalan HP 59, Sokalan HP 56, Sokalan HP 66 and Sokalan HP 70.

In preferred embodiments, the composition of the invention comprises a builder. Specially suitable for use herein are compositions comprising nanoparticle-protease compatibilizer selected from linear polyamines, polyalkylene polyamines, polyamidoamines, polyimines, polyethyleneimines and mixtures thereof in combination with a builder, in particular a polycarboxylate builder. Preferably the polycarboxylate builder is present in the composition of the invention in a percentage of from about 1 to about 20% by weight of the composition, more preferably from about 2 to about 10% by weight of the composition.

In other preferred embodiments the composition comprises an aminocarboxylate builder, in particular MGDA (methyl glycine di-acetic acid), GLDA (glutamic acid-N,N-diacetate) or mixtures thereof. These compositions no only provide excellent cleaning but they also have a good environmental profile. Especially preferred are compositions comprising MGDA, GLDA or mixtures thereof and a nanoparticle-protease compatibilizer selected from linear polyamines, polyalkylene polyamines, polyamidoamines, polyimines, polyethyleneimines and mixtures thereof.

The composition of the invention can be in any physical form, solid, liquid, gel, etc. Preferred for use herein is a compositions in solid form, for example powder, either loose powder or compressed powder. Preferably the composition of the invention is free of anionic surfactants.

In a preferred embodiment the nanoparticles and the nanoparticle-protease compatibilizer are in a weight ratio of from about 1:10 to 1:10, more preferably from about 1:0.5 to 1:5 and specially from about 1:1 to about 1:1.5.

The compositions of the invention provide an excellent cleaning even in the absence of traditional builders. Thus according to another embodiment of the invention, the composition comprises less than 10% by weight of the composition of phosphate builder, preferably less than 5% and more preferably less than 2%. This composition is excellent from an environmental viewpoint.

According to a second aspect of the present invention, there is provided a method of cleaning a soiled load (i.e., soiled housewares such as pots, pans, dished, cups, saucers, bottles, glassware, crockery, kitchen utensils, etc) in an automatic dishwasher, the method comprises the step of contacting the load with the compositions of the invention. The method of the invention is especially effective for tough food cleaning, including cooked-, baked- and burnt on soils. The method also provides second time benefits and excellent finishing and care, including glass care and metal care.

The method of the invention allows for the use of a wide range of nanoparticle concentrations. The concentration of nanoparticle in the wash liquor is preferably from about 50 ppm to about 2,500 ppm, more preferably from about 100 to about 2,000 and especially from about 200 to about 1,000 ppm.

In a preferred method embodiment, the glassware/tableware is treated sequentially by firstly, delivering the builder into the wash liquor, followed by the delivery of nanoparticles, i.e., 90% by weight of the total builder is delivered at least 3 minutes, preferably at least 5 minutes earlier than 90% by weight of the total nanoparticles.

It is also preferred that the composition comprises from about 2 to about 60%, more preferably from 5 to 50% by weight thereof of nanoparticles (or nanoparticles precursor) and from about 2 to about 60%, more preferably from 5 to 50% by weight thereof of nanoparticle-protease compatibilizer. Preferably the composition comprises an alkalinity source in a level of from about 1 to about 40%, more preferably from about 5 to about 35% by weigh of the composition. Preferably, the composition comprises a source of univalent ions, in particular sodium or potassium hydroxide. Also preferred are compositions free of compounds which form insoluble calcium or magnesium salt, such as carbonates and silicates. Preferably the composition comprises a builder, more preferably a non-phosphate builder, in a level of from about 10 to about 60%, preferably from about 20 to 50% by weigh of the composition.

### DETAILED DESCRIPTION OF THE INVENTION

The present invention envisages a composition comprising nanoparticles (or a nanoparticle precursor), a protease and a polymeric nanoparticle-protease compatibilizer, the invention also envisages a method of automatic dishwashing wherein the wash liquor comprises the composition of the invention. The method and composition provide excellent removal of tough food soils from cookware and tableware, in particular starchy and proteinaceous soils.

Nanoparticles

The nanoparticles of the composition of the invention are preferably inorganic nanoparticles.

Preferred inorganic nanoparticles can be selected from the group comprising metal oxides, hydroxides, clays, oxy/hydroxides, silicates, phosphates and carbonates. Nanoparticles selected from the group consisting of metal oxides and clays are preferred for use herein. Examples include silicon dioxide, aluminium oxide, zirconium oxide, titanium dioxide, cerium oxide, zinc oxide, magnesium oxide, clays, tin oxide, iron oxides (Fe₂O₃, Fe₃O₄) and mixtures thereof.

In one aspect, the nanoparticles for use in the present invention are layered clay minerals (referred herein sometimes as clays). Suitable layered clay minerals include those in the geological classes of smectites, kaolins, illites, chlorites, attapulgites and mixed layer clays. Smectites, for example, include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. Mites include bravaisite, muscovite, paragonite, phlogopite and biotite. Chlorites include corrensite, penninite, donbassite, sudoite, pennine and clinochlore. Atta-pulgites include sepiolite and polygorskyte. Mixed layer clays include allevardite and vermiculitebiotite.

The layered clay minerals may be either naturally occurring or synthetic. Natural or synthetic hectorites, montmorillonites and bentonites are suitable for use herein, especially preferred for use herein are hectorites clays commercially available. Typical sources of commercial hectorites are the LAPONITES from Rockwood Additives Limited; Veegum Pro and Veegum F from R. T. Vanderbilt, U.S.A.; and the Barasyms, Macaloids and Propaloids from Baroid Division, National Read Comp., U.S.A.

Natural clay minerals which may be used typically exist as layered silicate minerals and less frequently as amorphous minerals. A layered silicate mineral has SiO tetrahedral sheets arranged into a two-dimensional network structure. A 2:1 type layered silicate mineral has a laminated structure of several to several tens of silicate sheets having a three layered structure in which a magnesium octahedral sheet or an aluminum octahedral sheet is sandwiched between two sheets of silica tetrahedral sheets.

Synthetic hectorite is commercially marketed under the trade name LAPONITE™ by Rockwood Additives Limited. There are many grades or variants and isomorphous substitutions of LAPONITE™ marketed. Examples of commercial hectorites are Lucentite SWN™, LAPONITE S™, LAPONITE XLS™, LAPONITE RD™, LAPONITE B™ and LAPONITE RDS™. Generally LAPONITE™ has the formula: [Mg_{w}LiₓSi₈O₂₀OH_{4-y}F_{y}]^{z-} wherein w=3 to 6, x=0 to 3, y=0 to 4, z=12-2w-x, and the overall negative lattice charge may be balanced by counter-ions; and wherein the counter-ions are selected from the group consisting of Na+, K+, NH4+, Cs+, Li+, Mg++, Ca++, Ba++, N(CH3)4+ and mixtures thereof.

Preferred for use herein is the synthetic hectorite commercially available under the name Laponite® RD. Synthetic hectorites, have been found better for cleaning than other nanoparticles.

Clay nanoparticles (also referred herein as nanoclyas) are charged crystals having a layered structure. The top and bottom of the crystals are usually negatively charged and the sides are positively charged, at alkaline pH. Due to the charged nature of nanoclays, they tend to aggregate in solution to form large structures that do not effectively contribute to the cleaning. Moreover, these structures may deposit on the washed load leaving an undesirable film on them. In particular the nanoclays tend to aggregate in the presence of calcium and magnesium found in the wash water. A key requirement of the composition and method of the invention is the nanoclay to be dispersed in the wash liquor. By “dispersed” is meant that the nanoclay is in the form of independent crystals, in particular in the form of individual crystals having a particle size of from about 10 nm to about 300 nm, preferably from about 20 nm to about 100 nm and especially form about 30 to about 90 nm The particle size of the crystals can be measured using a Malvern zetasizer instrument. The nanoclay particle size referred to herein is the z-average diameter, an intensity mean size.

Nanoparticle-Protease Compatibilizer

A polymeric material is considered a nanoparticle-protease compatibilizer if the activity of a protease at a given pH (10.5) in a solution containing the compatibilizer, in the presence of nanoparticles is at least 40%, preferably at least 50%, more preferably at least 70% or most preferably at least 80% of that of a solution comprising the protease (i.e., free of nanoparticles and nanoparticle-protease compatibilizer). The method used to calculate the activity of the protease is a DMC assay. The absorbance of a solution containing the protease (and the DMC reagents) is compared with the absorbance of a solution containing the protease (and the DMC reagents), plus the nanoparticles and the polymer. Absorbance and activity are directly related so the absolute value of the protease activity is not needed for the purpose of evaluating whether a polymer is a nanoparticle-protease compatibilizer.

Assay for Protease Activity

Protease activity is measured using Dimethyl Casein (DMC). The protease used is FN3 DS BS 8%, available from Novozymes.

The test is performed as detailed herein below:

Equipment

A spectrophotometer (Ultraspec 2000) fitted with a heated Peltier cell is used.

Reagents Preparation

Basic Reagents for Protease Activity Test

### 2,4,6 trinitro benzene sulphonic acid Solution (TNBSA) (Colour Agent)

This material must be made fresh on each day of use

A 0.8%v/v solution of 2,4,6-trinitrobenze sulphonic acid in deionised water is prepared, by measuring 80 μl TNBSA in deionised water and diluting it to 100 ml.

### 0.4% N,N, dimethyl casein (DMC) (Substrate)

Solution A: dissolve exactly 3.4043 g of potassium dihydrogen orthophosphate in deionised water and dilute to 250 ml.

Solution B: dissolve exactly 4.851 g of sodium tetraborate in deionised water and dilute to 250 ml.

Final solution: boil 150 ml of deionised water, add 1 g of DMC and stir to dissolve. Add 5 ml of solution A and 45 ml of solution B. Filter through a Whatman 54 filter paper, cool, check that the pH is 9±0.1, adjusting with 4N sodium hydroxide or boric acid solution if necessary, and dilute to 250 ml with deionised water.

Sodium Sulphite Solution, 0.25% Aqueous Solution (Bleach Quencher)

Dissolve exactly 1.25 g of sodium sulphite in 500 ml of deionised water.

Nanoparticle+polymer solution

An aqueous solution comprising 267 ppm of nanoparticles and 800 ppm, preferably 600 ppm, more preferably 400 ppm and especially 200 ppm of polymer and having a pH of 10.5 is prepared, as detailed herein below.

A 268.34 ppm nanoparticle solution is prepared by adding 0.26834 g of nanoparticles into 1 litre of deionised water with high agitation (600-1000 rpm) to avoid the formation of lumps. The solution is stirred for at least 30 mins and then put it into ultrasonic water bath for another 30 mins to ensure that the nanoparticles have fully dispersed in deionised water. Then, the pH is adjusted to 10.5 by using 1M NaOH solution.

A series of 8%, 6%, 4% and 2% by weight polymer solution is prepared by dissolving 0.8 g, 0.6 g 0.4 g and 0.2 g of polymer in 10 g of deionised water, respectively. Then, the pH is adjusted to 10.5 by using 1M NaOH solution.

A solution comprising nanoparticles (267 ppm) and polymer (800, preferably 600 ppm, more preferably 400 and especially 200 ppm) is prepared by adding 2 ml of 8% polymer solution, preferably 2 ml of 6% polymer solution, more preferably 2 ml of 4% polymer solution and especially 2 ml 2% polymer solution to 398 ml of the nanoparticle solution. The solution is stirred at 600 rpm for 24 hours.

1) Activity of FN3 in pH10.5 Deionised Water with 5 ppm Ca2+

(1-a) 1 ml 2000 ppm Ca2+ is added into 399 ml pH10.5 deionised water and mix it.

(1-b) 1 ml solution from (a) is transferred to a glass tube and 0.7 ml sodium sulphite, 2 ml DMC solution, and 1 ml TNBSA solution are added. The solution is stirred on a Votex stirred for 15 seconds, and the resultant solution is incubated for 2 mins and 15 seconds at 40° C. The solution is then transferred into the Spectrophotometer and the absorbance recorded as blank reading. The Spectrophotometer is controlled by computer; temperature is set at 40° C., wavelength is set at 422 nm

(1-c) 0.0128 g FN3#DS BS 8% (activity of prill: 123.2 mg/g) prill are added into the solution 1-a and stirred for 5 mins to allow the protease to be released from the prill; the procedure 1-b is repeated after 5 mins stirring and the absolute absorbance of FN3 solution is recorded. The real absorbance of FN3 is equal to the absolute absorbance of FN3 minus the absolute absorbance of blank.

2) Activity of FN3 in pH 10.5 267 ppm Nanoparticle Polymer Solution and 5 ppm Ca2+

(2-a) The procedure 1-a to 1-c are repeated using the nanoparticles polymer solution instead of the pH 10.5 deionised water in step 1-a. The real absorbance of FN3 in the presence of nanoparticles and polymer is equal to the absolute absorbance of FN3 in the presence of nanoparticle and polymer minus the absorbance of nanoparticle and polymer.

If the protease (FN3) activity (as determined by absorbance at 422 nm) of solution 2 is at least 40%, preferably at least 50%, more preferably at least 70% or most preferably at least 80% that of solution 1, then the polymer is said to be a nanoparticle-protease compatibilizer within the meaning of the invention.

The absorbance of FN3 in a pH 10.5 solution comprising nanoparticles and 5 ppm of Ca230 has been found to be around 20% of that of the FN3 in the absence of nanoparticle, this result illustrate the extent to which nanoparticles and protease can negatively interact.

Polymeric Nanoparticle-Protease Compatibilizer

Suitable compatibilizer polymers should have a molecular weight of from 500 to 1,000,000, more preferably from 1,000 to 200,000, especially 5,000 to 100,000.

A composition that has been found to give excellent results comprises from about 2 to 60%, preferably from 5 to 50% by weight of the composition of nanoclay, from about 1 to about 40%, preferably from about 5 to about 35% by weight of the composition of an alkalinity source, from about 10 to about 60%, preferably from about 2 to about 50% by weight of the composition of a compatibilizer, from about 5 to about 40%, preferably from about 10 to about 30% by weight of the composition of bleach and from about 0.5 to about 10%, preferably from about 0.01 to about 2% by weight of the composition of active enzyme.

Preferably the wash liquor has a pH of from about 9 to about 12, more preferably from about 10 to about 11.5 and an ionic strength of from about 0.001 to about 0.02, more preferably from about 0.002 to about 0.015, especially from about 0.005 to about 0.01 moles/l. The method provides excellent cleaning, in particular on starch containing soils and on proteinaceous soils. Heavily soiled items such as those containing burn-on, baked-on or cook-on starchy food such as pasta, rice, potatoes, wholemeal, sauces thickened by means of starchy thickeners, etc. are easily cleaned using the method of the invention.

Ionic Strength

Preferably the wash liquor in which the composition of the invention is used, has an ionic strength of from about 0.001 to about 0.02, more preferably from about 0.002 to about 0.015, especially form about 0.005 to about 0.01 moles/l.

Ionic strength is calculated from the molarity (m) of each ionic species present in solution and the charge (z) carried by each ionic species. Ionic strength (I) is one half the summation of m.z² for all ionic species present i.e.

I=½Σm.z²

For a salt whose ions are both univalent, ionic strength is the same as the molar concentration. This is not so where more than two ions or multiple charges are involved. For instance a 1 molar solution of sodium carbonate contains 2 moles/litre of sodium ions and 1 mole/litre of carbonate ions carrying a double charge. Ionic strength is given by:

I=½[2(1²)+1×(2²)]=3 moles/litre

Alkalinity Source

Examples of alkalinity source include, but are not limited to, an alkali hydroxide, alkali hydride, alkali oxide, alkali sesquicarbonate, alkali carbonate, alkali borate, alkali salt of mineral acid, alkali amine, alkaloid and mixtures thereof. Sodium carbonate, sodium and potassium hydroxide are preferred alkalinity sources for use herein, in particular sodium hydroxide. The alkalinity source is present in an amount sufficient to give the wash liquor a pH of from about 9 to about 12, more preferably from about 10 to about 11.5. Preferably, the composition herein comprises from about 1% to about 40%, more preferably from about 2% to 20% by weight of the composition of alkaline source.

The wash liquor comprises an alkalinity source in an amount sufficient to give the wash liquor the desired pH. Preferably the wash liquor contains from about 20 to about 1,200 ppm, more preferably from about 100 to about 1,000 of an alkalinity source. It is especially preferred that the alkalinity source comprises a source of univalent ions. Univalent ions contribute to high alkalinity and at the same time hardly raise the ionic strength of the wash solution. Preferred alkalinity sources for use herein are metal hydroxides, in particular sodium or potassium hydroxide and especially sodium hydroxide.

Builder

Suitable builder to be used herein may be any builder known to those skilled in the art such as the ones selected from the group comprising phosphonates, amino carboxylates or other carboxylates, or polyfunctionally-substituted aromatic builders or mixtures thereof.

A preferred builder for use herein is a low molecular weight polyacrylate homopolymer, having a molecular weight of from about 1,000 to about 30,000, preferably from about 2,000 to about 20,000 and more preferably from about 3,000 to about 12,000. Another preferred builder for use herein is an aminocarboxylate, in particular MGDA (methyl glycine di-acetic acid) and GLDA (glutamic acid-N,N-diacetate).

In other preferred embodiments the builder is a mixture of a low molecular weight polyacrlyate homopolymer and another builder, in particular an amino polycarboxylate builder. It has been found that the combination of low molecular weight polyacrylates with amino polycarboxylates is very good in terms of soil removal. MGDA and GLDA have been found most suitable amino polycarboxylates for use herein.

Phosphonate suitable for use herein may include etidronic acid (1-hydroxyethylidene-bisphosphonic acid or HEDP) as well as amino phosphonate compounds, including amino alkylene poly(alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonates to be used herein are diethylene triamine penta methylene phosphonates. Such phosphonates are commercially available from Monsanto under the trade name DEQUEST®.

Polyfunctionally-substituted aromatics may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

Suitable amino carboxylates for use herein include nitrilotriacetates (NTA), ethylene diamine tetra acetate (EDTA), diethylene triamine pentacetate (DTPA), N-hydroxyethylethylenediamine triacetate, nitrilotri-acetate, ethylenediamine tetraproprionate, triethylenetetraaminehexa-acetate (HEDTA), triethylenetetraminehexaacetic acid (TTHA), propylene diamine tetracetic acid (PDTA) and, both in their acid form, or in their alkali metal salt forms. Particularly suitable to be used herein are diethylene triamine penta acetic acid (DTPA) and propylene diamine tetracetic acid (PDTA). A wide range of aminocarboxylates is commercially available from BASF under the trade name Trilon®. A preferred biodegradable amino carboxylate for use herein is ethylene diamine N,N′-disuccinic acid (EDDS), or alkali metal or alkaline earth salts thereof or mixtures thereof. Ethylenediamine N,N′-disuccinic acids, especially the (S,S) isomer have been extensively described in U.S. Pat. No. 4,704,233, Nov. 3, 1987 to Hartman and Perkins. Ethylenediamine N,N′-disuccinic acid is, for instance, commercially available under the tradename ssEDDS® from Palmer Research Laboratories.

Aminodicarboxylic acid-N,N-dialkanoic acid or its salt are also suitable amino carboxylates for use herein. The compounds can be represented by the following formula:

MOOC—CHZ¹-NZ²Z³

wherein each of Z¹, Z² and Z³ independently represents a COOM-containing group; wherein each of M independently represents either of a hydrogen atom, sodium, potassium or amine ion.

In the above formula, Z¹, Z² and Z³ may either be same with or different from each other, and examples of those groups are found among carboxymethyl group, 1-carboxyethyl group, 2-carboxyethyl group, 3-carboxypropan-2-yl group, their salts, etc. As concrete examples, there are glutamic acid-N,N-diacetic acid, glutamic acid-N,N-dipropionic acid, and their salts. Above all, glutamic acid-N,N-diacetate is especially preferred, in particular L-glutamic acid-N,N-diacetate.

Other suitable builders include ethanoldiglycine and methyl glycine di-acetic acid (MGDA).

Further carboxylates useful herein include low molecular weight hydrocarboxylic acids, such as citric acid, tartaric acid malic acid, lactic acid, gluconic acid, malonic acid, salicylic acid, aspartic acid, glutamic acid, dipicolinic acid and derivatives thereof, or mixtures thereof.

Suitable carboxylated polymers include polymeric polycarboxylated polymers, including homopolymers and copolymers. Preferred for use herein are low molecular weight (from about 2,000 to about 30,000, preferably from about 3,000 to about 20,000) homopolymers of acrylic acid. They are commercially available from BASF under the Sokalan PA range. An especially preferred material is Sokalan PA 30. Sodium polyacrylate having a nominal molecular weight of about 4,500, is obtainable from Rohm & Haas under the tradename ACUSOL® 445N. Other polymeric polycarboxylated polymers suitable for use herein include copolymers of acrylic acid and maleic acid, such as those available from BASF under the name of Sokalan CP and AQUALIC® ML9 copolymers (supplied by Nippon Shokubai Co. LTD).

Other suitable polymers for use herein are polymers containing both carboxylate and sulphonate monomers, such as ALCOSPERSE® polymers (supplied by Alco) and Acusol 588 (supplied by Rohm&Hass).

With reference to the polymers described herein, the term weight-average molecular weight (also referred to as molecular weight) is the weight-average molecular weight as determined using gel permeation chromatography according to the protocol found in Colloids and Surfaces A. Physico Chemical & Engineering Aspects, Vol. 162, 2000, pg. 107-121. The units are Daltons.

If present, the composition of the invention comprises from about 5 to about 40%, more preferably from about 10 to about 30% by weight of the composition of a builder. Preferably the composition is free of phosphate builder.

Other Cleaning Actives

Any traditional cleaning ingredients can be used in the composition and method of the invention.

Bleach

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-1,466,799. The weight ratio of the mixed salt coating material to percarbonate lies in the range from 1:200 to 1:4, more preferably from 1:99 to 1 9, and most preferably from 1:49 to 1:19. Preferably, the mixed salt is of sodium sulphate and sodium carbonate which has the general formula Na2S04.n.Na2CO3 wherein n is from 0.1 to 3, preferably n is from 0.3 to 1.0 and most preferably n is from 0.2 to 0.5.

Another suitable coating material providing in product stability, comprises sodium silicate of Si02:Na20 ratio from 1.8:1 to 3.0:1, preferably L8:1 to 2.4:1, and/or sodium metasilicate, preferably applied at a level of from 2% to 10%, (normally from 3% to 5%) Of Si02 by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein.

Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein.

The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

If present, the composition of the invention comprises from about 5 to about 40%, more preferably from about 10 to about 30% by weight of the composition of a bleach. Preferably the composition comprises percarbonate bleach.

Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the composition.

Bleach Catalyst

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16. Bleach catalyst if included in the compositions of the invention are in a level of from about 0.1 to about 10%, preferably from about 0.5 to about 2% by weight of the composition.

Surfactant

Preferably the compositions (methods and products) for use herein are free of surfactants. A preferred surfactant for use herein is low foaming by itself or in combination with other components (i.e. suds suppressers). Preferred for use herein are low and high cloud point nonionic surfactants and mixtures thereof including nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of a detergent composition. Preferred surfactant for use herein, if any, are low foaming and include low cloud point nonionic surfactants and mixtures of higher foaming surfactants with low cloud point nonionic surfactants which act as suds suppresser therefor.

Enzyme

Suitable proteases include metalloproteases and serine proteases, including neutral or alkaline microbial serine proteases, such as subtilisins (EC 3.4.21.62). Suitable proteases include those of animal, vegetable or microbial origin. Microbial origin is preferred. Chemically or genetically modified mutants are included. The protease may be a serine protease, preferably an alkaline microbial protease or a chymotrypsin or trypsin-like protease. Examples of neutral or alkaline proteases include:
(a) subtilisins (EC 3.4.21.62), especially those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, DEA6022216A1 and DEA 6022224A1.
(b) trypsin-like or chymotrypsin-like proteases, such as trypsin (e.g., of porcine or bovine origin), the Fusarium protease described in WO 89/06270 and the chymotrypsin proteases derived from Cellumonas described in WO 05/052161 and WO 05/052146.
(c) metalloproteases, especially those derived from Bacillus amyloliquefaciens decribed in WO 07/044993A2.

Preferred commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novo Nordisk A/S (Denmark), those sold under the tradename Maxatase®, Maxacal®, Maxapem®, Properase®, Purafect®, Purafect Prime®, Purafect Ox®, FN3® , FN4® and Purafect OXP® by Genencor International, and those sold under the tradename Opticlean® and Optimase® by Solvay

Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.
(b) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:

26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484 that also preferably contain the deletions of D183* and G184*.
(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.

Suitable commercially available alpha-amylases are DURAMYL®, LIQUEZYME® TERMAMYL®, TERMAMYL ULTRA®, NATALASE®, SUPRAMYL®, STAINZYME®, STAINZYME PLUS®, FUNGAMYL® and BAN® (Novozymes A/S), BIOAMYLASE-D(G), BIOAMYLASE® L (Biocon India Ltd.), KEMZYM® AT 9000 (Biozym Ges. m.b.H, Austria), RAPIDASE®, PURASTAR®, OPTISIZE HT PLUS® and PURASTAR OXAM® (Genencor International Inc.) and KAM® (KAO, Japan). In one aspect, preferred amylases are NATALASE®, STAINZYME® and STAINZYME PLUS® and mixtures thereof.

Enzymes are preferably added herein as prills, granulates, or cogranulates at levels typically in the range from about 0.0001% to about 5%, more preferably from about 0.001% to about 2% pure enzyme by weight of the cleaning composition. Preferred for use herein are proteases, amylases and in particular combinations thereof.

Low Cloud Point Non-Ionic Surfactants and Suds Suppressers

The suds suppressers suitable for use herein include nonionic surfactants having a low cloud point. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., BASF Poly-Tergent® SLF18) and epoxy-capped poly(oxyalkylated) alcohols (e.g., BASF Poly-Tergent® SLF18B series of nonionics, as described, for example, in U.S. Pat. No. 5,576,281).

Preferred low cloud point surfactants are the ether-capped poly(oxyalkylated) suds suppresser having the formula:

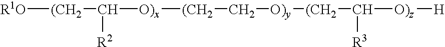

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

The nanoparticles can negatively interact with some cleaning actives either in the wash liquor. In preferred embodiments of the method of the invention, there is a delayed release of the nanoparticles with respect to other ingredients. This ameliorates negative interactions and improves cleaning performance. By “delayed release” is meant that at least 50%, preferably at least 60% and more preferably at least 80% of one of the components is delivered into the wash solution at least one minute, preferably at least two minutes and more preferably at least 3 minutes, than at less than 50%, preferably less than 40% of the other component. The nanoparticle can be delivered first and the enzyme second or vice-versa. Good cleaning results are obtained when the enzyme, in particular protease, is delivered first and the nanoclay second. Delayed release can be achieved by for example using a multi-compartment pouch wherein different compartments have different dissolution rates, by having multi-phase tablets where different phases dissolve at different rates, having coated bodies, layered particles, etc.

Water-Soluble Pouch

In a preferred embodiment of the present invention the detergent composition is in the form of a water-soluble pouch, more preferably a multi-phase unit dose pouch, preferably an injection-moulded, vacuum- or thermoformed multi-compartment, wherein at least one of the phases comprises the nanoparticles. Preferred manufacturing methods for unit dose executions are described in WO 02/42408 and EP 1,447,343 B1. Any water-soluble film-forming polymer which is compatible with the compositions of the invention and which allows the delivery of the composition into the main-wash cycle of a dishwasher can be used as enveloping material.

Most preferred pouch materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

Delayed Release

Delayed release can be achieved by means of coating, either by coating active materials or particle containing active material. The coating can be temperature, pH or ionic strength sensitive. For example particles with a core comprising either nanoparticles (or a nanoparticle precursor) or enzyme and a waxy coating encapsulating the core are adequate to provide delayed release. For waxy coating see WO 95/29982. pH controlled release means are described in WO 04/111178, in particular amino-acetylated polysaccharide having selective degree of acetylation.

Other means of obtaining delayed release are pouches with different compartments, where the compartments are made of film having different solubilities (as taught in WO 02/08380).

Delayed release can also be obtained by layering of actives in solid particles as described in WO2007/146491.

In the case of free builder formulations it has been found that an improved cleaning can be obtained by delivering enzymes and an alkalinity source to the wash liquor, followed by bleach and then the nanoparticles and the nanoparticle-protease compatibilizer. In the case of build compositions it has been found that an improved cleaning is obtained if the builder and alkalinity source are delivered first, followed by enzymes then nanoparticle-protease compatibilizer and finally nanoparticles.

In the case in which the cleaning composition comprises layered particles comprising different actives in different layers, it has been found that excellent cleaning is provided by particles comprising nanoparticles in the core of the particle, this allows for delayed release of the nanoparticles into the wash liquor.

### Examples

### Abbreviations Used in Examples

In the examples, the abbreviated component identifications have the following meanings:
MGDA Disolvine GL (tetrasodim N,N-bis(carboxylato methyl-L-glutamate) from Azko Nobel
GLDA Glutamic-N,N-diacetic acid
STPP Sodium tripolyphosphate anhydrous
KOH Potassium Hydroxide
Sodium Anhydrous sodium carbonate
Carbonate
Laponite Laponite® RD synthetic hectorite available from Rockwood Additives Limited.
Polymer Sokalan HP 53 available from BASF
PA30 Polyacrylic acid available from BASF
Percarbonate Sodium percarbonate of the nominal formula 2Na₂CO₃.3H₂O₂
TAED Tetraacetylethylenediamine
Bleach catalyst Cobalt bleach catalyst
Protease Protease PX available from Novozymes
Amylase Stainzyme Plus available from Novozymes

In the following examples all levels are quoted as parts by weight of the composition.

Example 1 and 5 illustrate the use of compositions comprising a synthetic clay, Laponite®, for the removal of different types of soil in a dishwasher. The dishwasher load comprises different soils and different substrates: Macaroni & Cheese on stainless steel baked for 7 minutes at 200° C., scrambled eggs on ceramic bowls microwaved for 2 minutes, cooked rice on ceramic dishes, scrambled eggs on stainless steel slides and cooked pasta on glass slides. The dishware is allowed to dry for 12 hours and then is ready to use. The dishware is loaded in a dishwasher (i.e GE Model GSD4000, Normal Wash at 50° C.).

The cleaning was excellent in all cases.

| | 100% activity | | | | |
|---|---|---|---|---|---|
| | Example 1 | Example 2 | Example 3 | Example 4 | Example 5 |
| MGDA | 0 | 13% | 0 | 0 | 9.5% |
| GLDA | 0 | 0 | 15.8% | 0 | 0 |
| STPP | 0 | 0 | 0 | 25.9% | 0 |
| NaOH | 6.0% | 5.2% | 5% | 0 | 0 |
| Sodium | 0 | 0 | 0 | 18.9% | 26.7% |
| Carbonate | | | | | |
| Laponite | 23.9% | 20.8% | 20.1% | 14.0% | 15.3% |
| Polymer | 31.7% | 27.6% | 26.7% | 18.6% | 20.2% |
| PA30 | 0 | 0 | 0 | 0 | 3.81% |
| Percarbonate | 26.3% | 22.9% | 22.2% | 15.4% | 16.8% |
| TAED | 7.2% | 6.2% | 6.0% | 4.21% | 4.58% |
| Catalyst | 0.02% | 0.017% | 0.017% | 0.012% | 0.013% |
| Protease | 2.4% | 2.08% | 2.01% | 1.40% | 1.53% |
| Amylase | 2.0% | 1.77% | 1.71% | 1.19% | 1.30% |
| Perfume | 0.48% | 0.42% | 0.40% | 0.28% | 0.31% |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An alkaline cleaning composition for use in an aqueous medium comprising nanoparticles or a nanoparticles precursor, a protease and a polymeric nanoparticle-protease compatibilizer.

2. A cleaning composition according to claim 1 wherein the polymeric nanoparticle-protease compatibilizer is selected from polymers comprising non-ionic groups.

3. A cleaning composition according to claim 1 wherein the polymeric nanoparticle-protease compatibilizer comprises a moiety comprising at least one heteroatom selected from the group consisting of nitrogen, oxygen, sulphur and mixtures thereof.

4. A cleaning composition according to claim 1 wherein the polymeric nanoparticle-protease compatibilizer comprises a moiety and the moiety comprises amines, amides, imides, heterocyclic groups, alkylene oxides, alkylene glycols, alkyl glycol ethers or mixtures thereof.

5. A cleaning composition according to claim 1 wherein the nanoparticle-protease compatibilizer is a comb polymer comprising a backbone and pendant groups, wherein the backbone comprises a moiety comprising nitrogen and the pendant groups are non-ionic.

6. A cleaning composition according to claim 1 wherein the nanoparticles are synthetic clay.

7. A cleaning composition according to claim 1 wherein the nanoparticles and the nanoparticle-protease compatibilizer are in a weight ratio of from about 1:10 to about 10:1.

8. A cleaning composition according to claim 1 further comprising a builder.

9. A cleaning composition according to claim 8, wherein the builder is a polycarboxylated polymeric builder.

10. A method of cleaning glassware/tableware in an automatic dishwashing machine comprising the step of contacting the glassware/tableware with a wash liquor comprising a composition according to claim 1, wherein the wash liquor comprises from about 50 to about 500 ppm of nanoparticle.

11. A method of cleaning glassware/tableware in an automatic dishwashing machine comprising the step of contacting the glassware/tableware with a wash liquor comprising a composition according to claim 1 further comprising a builder, wherein the builder is delivered into the wash liquor before the nanoparticles.

12. A particle comprising a nanoparticle precursor containing core surrounded by a polymeric surrounding layer.
